(19) United States
(12) Patent Application Publication
(10) Pub. No.: US 2008/0229888 A1
(43) Pub. Date: Sep. 25, 2008

(54) Stepless rotatable driving wrench

(76) Inventor: David A. Ishmael, Baton Rouge, LA (US)

Correspondence Address: MEREK, BLACKMON & VOORHEES, LLC, 673 S. WASHINGTON ST., ALEXANDRIA, VA, 22314, US

(21) Appl. No.: 11/723,993

(22) Filed: Mar. 23, 2007

(51) Int. Cl. B25B 13/46

(52) U.S. Cl. 81/63.1

(57) ABSTRACT

A stepless rotatable driving wrench having a unidirectional clutch acting on a driving element, wherein the driving element is preferably a square drive. The driving element is shiftable between two operable positions to project selectively from either side of the wrench so that driving in two opposed directions is enabled despite the unidirectional nature of the clutch. In each of the two operable positions, the driver operably projects from one side of the wrench while remaining entirely flush with the other side of the wrench. Ball detents releasably hold the driver in the selected operable position. Loss of the driver from either side of the wrench is prevented by an internal pin engaging a slot formed in the driver.

### BACKGROUND OF THE INVENTION

1. Field of the Invention

The present invention relates to hand tools, and more particularly, to rotary drivers or wrenches of the type that removably accept sockets and other tools.

2. Description of the Prior Art

Wrenches of the stepless type providing unidirectional action are known. As employed herein, unidirectional action will signify that when rotated in one direction, the wrench turns a socket or other tool that it drives, while in an opposite direction, the socket is not turned as the wrench freely rotates about the socket. This is a well-known feature of rotated wrenches, permitting a wrench to rotate a fastener or other driven element by moving the handle of the wrench through a limited arcuate range of motion alternatingly in opposed directions. This type of action is facile and convenient, and in some cases where maneuvering space is limited, may be necessary. Such wrenches typically employ overriding clutch type bearings located in the wrench head between a shank intended to engage and drive a socket or similar tool, and a generally circular structural member attached to the handle which holds the shank.

### SUMMARY OF THE INVENTION

The present invention provides a nearly stepless wrench (“infinitely adjustable”) of the type which would otherwise be a ratchet action wrench.

To be practical, a stepless wrench should be bi-directional in its action, reasonably compact, and reasonably inexpensive. The present invention answers the need by providing a stepless or nearly stepless wrench that is compact and inexpensive. The novel wrench utilizes a unidirectional clutch to rotate a preferably square driving element, hereinafter called a driver, which releasably engages sockets and other rotatable tools. The driver is contained in a head of the novel wrench such that it projects selectively from one side of the head while being flush with the other side of the head. The driver can be manually moved to project from either side of the head. A socket or other driven tool can be selectively rotated by selecting which side of the head the driver projects from.

The driver is held in its selected position within the head by a spring urged ball detent of known type. The driver has two such detents, one at each end. They are located such that when one side projects out from the head, the detent can retain a socket or other drivable tool having a groove which cooperates with the ball of the detent, while the detent of the other side engages a groove formed in the head of the tool. This arrangement releasably holds the driver in the selected direction of projection, while enabling the driver to be manually maneuvered to project from the other side of the tool head when desired. A yoke arrangement retains the driver in the head against casual removal that could occur, for example, by manually urging the driver past the point at which one ball detent engages the groove in the tool head.

The unidirectional clutch is preferably advantageously provided by existing commercial stepless bearings. A commercial bearing assembly may be retained within the head and cooperatively receives a cylindrical body along which the driver can move axially. A pin passing through and anchored within this body penetrates a slot formed in the driver. The slot and pin provide a yoke arrangement to retain the driver within the tool.

It is an object of a preferred invention to provide a bi-directional stepless wrench.

It is another object of the invention to utilize existing commercial unidirectional, stepless bearings to fabricate the bi-directional stepless wrench.

A further object of the invention is to enable the driver to project from one side of the head while being flush with the opposing side of the head.

Still another object of the invention is to positively retain the driver in the head despite being manually movable to either one of several projecting positions within the head.

U.S. Pat. No. 3,398,612, issued to Ronald W. Batten on Aug. 27, 1968, shows a driving tool which utilizes an over-running clutch and permits adjustment in position of projection of the driver. However, Batten requires two outwardly projecting flanges formed in the driver to retain the driver within the tool head. By contrast, the present invention has an internal yoke to accomplish this function, so that the present invention enables true flush relationship of the driver with the head of the tool at that side of the tool head opposite the projecting end of the driver.

U.S. Pat. No. 3,688,610, issued to Ronald J. Vlasin on Sep. 5, 1972, provides a driving tool utilizing an over-running clutch that utilizes a commercial clutch of the sort which may be utilized in the present invention. However, Vlasin does not provide the adjustably positioned and retained driver of the present invention.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a perspective view of a wrench according to one embodiment of the invention.

FIG. 2 is an exploded perspective view of the wrench of FIG. 1.

FIG. 3 is an enlarged plan partially cross sectional view of the upper left of FIG. 1.

FIG. 4 is a partially cut away perspective detail view of two of the components seen individually in FIG. 2.

FIG. 5 shows the components of FIG. 3, but with one component shifted in position relative to its prior position in FIG. 3.

FIG. 6 is an end elevational view of a component shown in FIG. 2.

FIG. 7 is a plan view of an alternative embodiment of the invention.

Similar reference characters denote corresponding features consistently throughout the attached drawings.

### DETAILED DESCRIPTION OF THE PREFERRED EMBODIMENTS

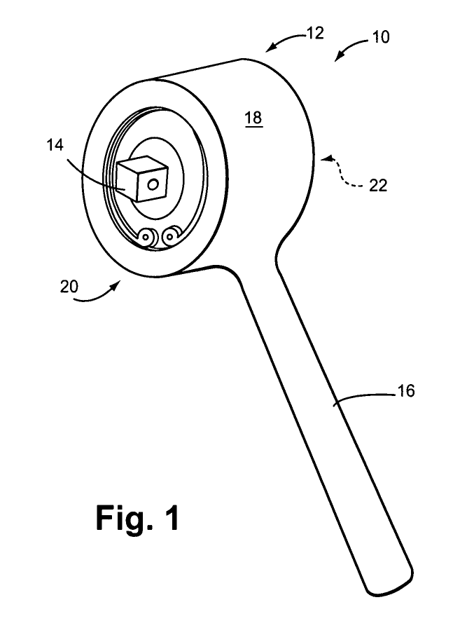

Referring first to FIG. 1, the present invention shows a stepless rotatable driving wrench 10 having a head 12 bearing a driver 14 for engaging a tool such as a socket (not shown) and a grasping element for enabling a person to grasp and maneuver head 12 for the purpose of rotatably driving the tool. In the embodiment shown, the grasping element takes the form of an elongated lever handle 16. Handle 16 is preferably elongated to the extent that its length exceeds the greatest diameter of head 12. Handle 16 has a proximal end fixed to head 12 and a distal end which in the embodiment of FIG. 1 is free. However, other forms (not shown) of the grasping element are possible. An example is forming the outer circumferential surface 18 of head 12 in a suitable way to promote grasp, such as by molding grips (not shown) into outer circumferential surface 18, or by providing a friction enhancing feature (not shown) such as by knurling, adhering a sandpaper like material, or providing outwardly extending spokes, among others, to outer circumferential surface 18.

Head 12 has a first service face or surface 20 and a second service face or surface 22 located on opposed sides of outer circumferential surface 18. A service face or surface 20 or 22 as employed herein denotes a face of wrench 10 which bears driver 14, so that the respective service face 20 or 22 is usable to drive a tool.

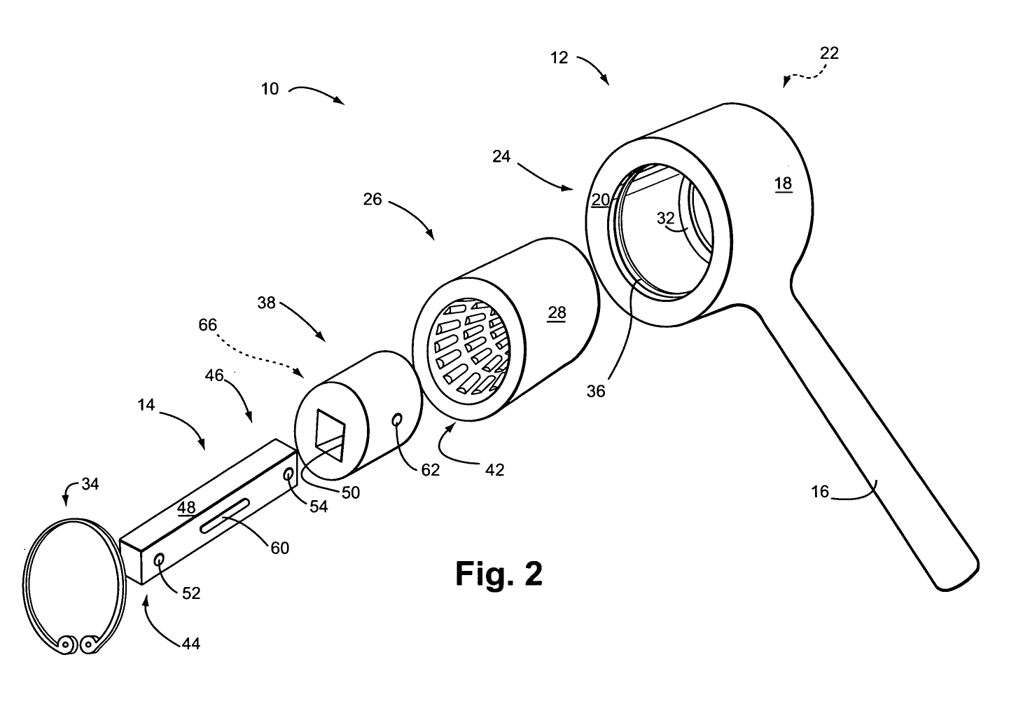

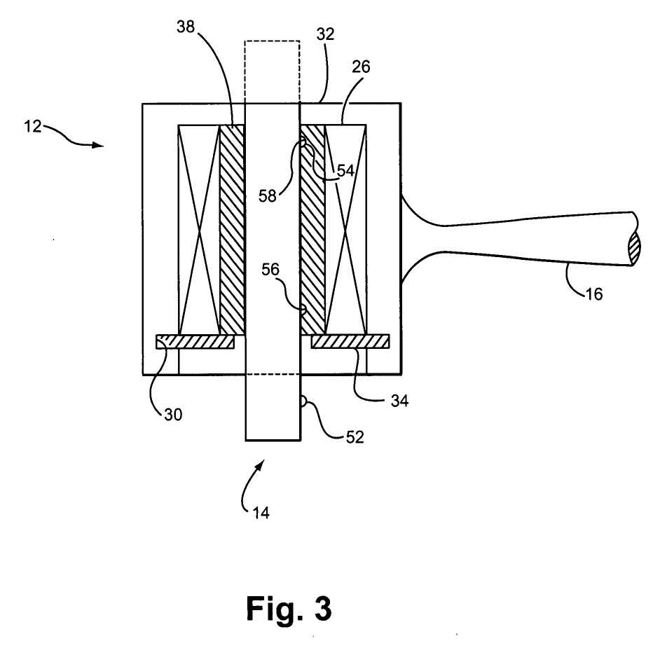

As clearly seen in FIG. 2, head 12 has a hollow center space 24 which extends between service surface 20 and service surface 22. Hollow center space 24 encloses a stepless unidirectional clutch 26 therein. Stepless unidirectional clutch 26 is preferably a commercially available bearing assembly available from sources such as the Torrington Bearing Company of Torrington, Conn. Stepless unidirectional clutch 26 has a cylindrical outer surface 28 which is slidably received in close cooperation with smooth inner surface 30 of head 12. Loss of stepless unidirectional clutch 26 through the opening of hollow center space 24 at service surfaces 20, 22 is prevented by interference. A releasable retainer 38, the purpose of which is explained hereinafter, is retained within hollow center space 24 at that end proximate service surface 22 by interference provided by a fixed interference member in the form of short inwardly projecting wall or flange 32 formed in head 12. At the other end of hollow center space 24, that end proximate service surface 20, corresponding interference is provided by a removable retaining element which enable insertion and removal of stepless unidirectional clutch 26. This element includes a clip 34, which may be a conventional spring action C-clip, which is dimensioned and configured to be received and seated within a groove 36 formed in smooth inner surface 30 of head 12. In summary, groove 36 and clip 34 oppose loss of driver 14 from head 12 by interference with driver 14. Flange 32, groove 36, and clip 34 are also seen in FIG. 3.

Still referring to FIG. 2, releasable retainer 38 provides an operable interface between driver 14 for engaging the tool to be driven and stepless unidirectional clutch 26. This interface enables driver 14 to be releasably and operably held within hollow center space 24 of head 12. Releasable retainer 38 provides the function of an adapter to adapt the configuration of the driver 14 to the interior of stepless unidirectional clutch 26. Releasable retainer 38 has an internal bore dimensioned and configured to enable driver 14 to slide along its longitudinal axis within releasable retainer 38. Releasable retainer 38 has a cylindrical outer surface 40 which is dimensioned and configured to be releasably engaged by bearings 42 that are exposed to the open center of stepless unidirectional clutch 26.

Driver 14 has a first non-circular drive end 44 and an opposed second non-circular drive end 46. A peripheral drive surface 48 is, when driver 14 is installed within releasable retainer 38, disposed to be contacted by and rotatably driven by stepless unidirectional clutch 26. Peripheral drive surface 48 will be understood to include all outward surface faces which could engage corresponding inner surface faces of longitudinal central passageway 50 formed along the length of releasable retainer 38. Driver 14 is of overall length greater than that of releasable retainer 38 such that one drive end 44 or 46 projects from one service surface 20 or 22 of head 12 when the other drive end 46 or 44 is flush with the other service surface 22 or 20 of head 12. Of course, it will be understood that the degree of projection is sufficient to engage a socket or other driven tool so as to enable driving action.

The purpose of releasable retainer 38 is to hold driver 14 to head 12 while being movable between two selectable operable positions wherein driver 14 projects from one side of head 12 while remaining flush with the other side of head 12. Fit of driver 14 with releasable retainer 38 enables slidable, ready manual movement of driver 14 between the two selectable positions.

Because such a great proportion of conventional tools utilize square drives, driver 14 preferably has configuration of a square drive, and is preferably substantially a parallelepiped apart from features such as slot 60 and balls 52, 54. It is preferred to utilize a configuration which cooperates with conventional rotary tools having square holes for receiving square drivers. Illustratively, square and hexagonal shanks are conventionally provided to drive sockets and other tools intended to be rotated. Of course, still other configurations such as the generally star shape of TORX™ tools could be provided.

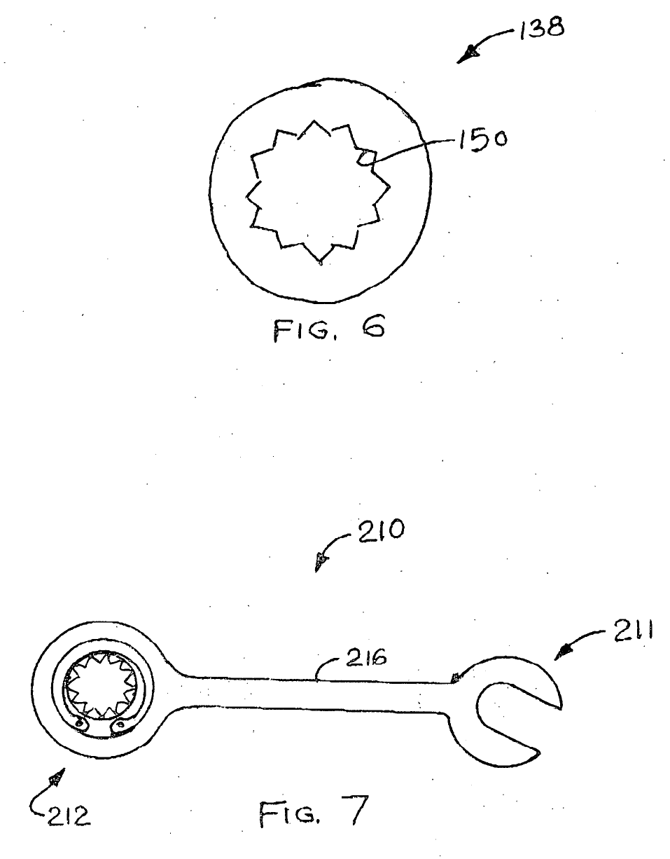

Central passageway 50 of releasable retainer 38 is depicted in FIG. 2 as being square so that it cooperates with and drivably receives the cross sectional square configuration of driver 14. Other configurations of the central passageway are also possible. As shown in FIG. 6, a releasable retainer 138 of an alternative embodiment has a central passageway 150 which is twelve pointed. Central passageway 150 is dimensioned and configured to receive and drive square driver 14 selectively in any of three different rotational orientations in a manner similar to that by which a twelve point socket (not shown) can engage a hexagonal nut in more than one rotational orientation. This succeeds because driver 14 is square in cross section along at least most of its length, including that portion engaged by central passageway 50 or 150.

Wrench 10 has a feature for preventing spontaneous release of driver 14 from head 12, which spontaneous release would otherwise enable driver 14 to slide spontaneously along its longitudinal axis relative to head 12. This feature utilizes a conventional ball detent comprising a spring urged ball which occupies a bore formed in driver 14. Many corresponding drivers in conventional ratchet action wrenches (not shown) have a conventional ball detent for releasably engaging a socket. In the present invention, two ball detents are provided, one near each end 44 or 46 of driver 14. Each ball detent is constructed similarly to conventional practice, and therefore need not be shown in extreme detail, and further will be shown only representatively as balls 52, 54. The balls perform not only the conventional function of releasably engaging a socket in the usual way, but also releasably secure driver 14 to releasable retainer 38 and therefore, ultimately to head 12. As seen in FIG. 3, releasable retainer 38 has two notches 56, 58 which are so located and configured such that in each of the two operable positions of driver 14, one ball 52 or 54 is exposed and can engage a socket or the like, and the other ball 54 or 52 engages an associated notch 58 or 56. In summary, the feature for preventing spontaneous release of driver 14 requires no additional structure apart from notches 56, 58 which are machined into driver 14, conventional spring urged balls being present for the conventional purpose of retaining sockets and like tools. FIG. 3 also illustrates the two operable positions of driver 14, wherein one position is shown with driver 14 shown in solid lines, and the other position is shown when driver 14 is located according to the broken lines.

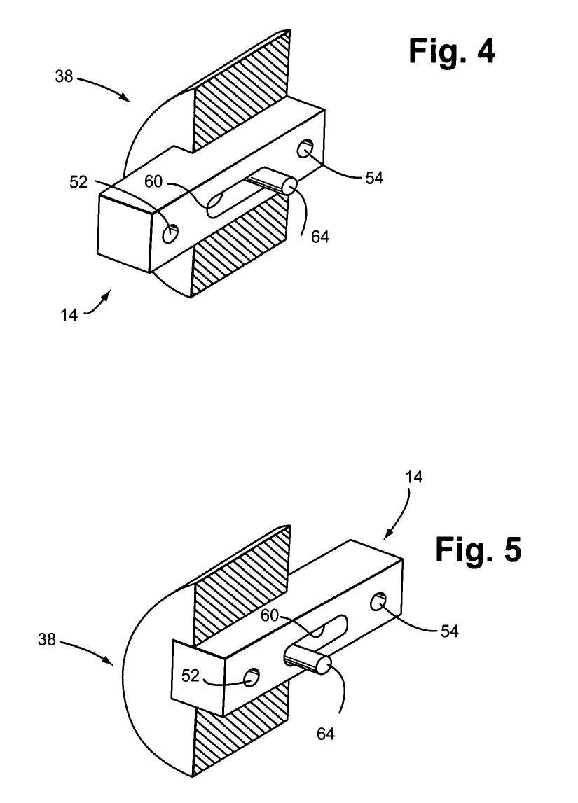

Wrench 10 also has a feature to positively prevent loss of driver 14 even should the ball detent fail to retain driver 14. Referring first to FIG. 2, it will be seen that driver 14 has a slot 60 formed therein, and releasable retainer 38 has a cross hole 62 defined therein. Turning now to FIG. 4, a pin 64 is fixed to releasable retainer 38. Pin 64 extends diametrically across releasable retainer 38, and is friction fit to cross hole 62 and to a corresponding opposed cross hole 66 also formed in releasable retainer 38. Pin 64 penetrates and occupies slot 60. Travel of driver 14 along its longitudinal axis within releasable retainer 38 is limited to a predetermined magnitude by the length of slot 60 due to interference with pin 64 that occurs at each extreme of travel. FIGS. 4 and 5 illustrate the two opposite limits of travel of driver 14. These limits correspond to the two operable positions of driver 14 with respect to head 12, as described above.

In a further alternative embodiment illustrated in FIG. 7. A first end 211 of the wrench 210 comprises an open wrench 211, well known to those of ordinary skill in the art. At the opposite end is a modified closed end wrench 212. As known to those skilled in the art, an “open wrench” is generally a wrench having one open side that can slide laterally onto a nut from the side. The open wrench is sized to fit a particular size nut. A “closed wrench” is generally a wrench having a closed shape for being placed axially onto a nut. The shape may be square or hexagonal, but is generally twelve sided as shown in FIG. 6, to receive the nut in as many orientations as possible so that the wrench does not have to be turned unduly to slide over the nut, or so that the nut can be rotated in close quarters by removing and replacing the wrench at quarter turn or less intervals.

Returning now to FIG. 7, to further increase the usefulness of the closed wrench 212, an infinitely adjustable clutch 218 is provided with a twelve-sided driver 220. The stepless unidirectional clutch 212 allows the driver to rotate in a single direction. Turning the tool in a first direction causes the driver to engage and turn a nut in the first direction. Turning the tool in a second direction will cause the tool to freewheel about the nut. To drive the nut in the opposite direction, the user would merely flip the wrench over and place the tool back over the nut. Of course, in other embodiments, second wrench head 211 could be replaced by other sizes and styles of wrenches, which different sizes and styles may include a wrench head generally identical to head 12, or differing from head 12 only in driver configuration or driver dimensions or both. Additionally, the closed wrench 212 could be sized as needed to fit a particular nut and could have various shapes (e.g., square, hexagonal, irregular) depending on the configuration of the nut to be engaged.

Referring again to FIG. 6, it will be appreciated that when releasable retainer 138 is employed, it would be possible to remove driver 14 and to utilize the resulting assembly as a stepless wrench incorporating an internal opening of a twelve point socket. The internal opening serves as a tool engaging surface for turning a tool or other work piece (neither shown). Of course, releasable retainer 138 could be replaced by other comparable releasable retainers (not shown) having tool engaging surfaces of configuration other than those of twelve point openings. Illustratively, square, hexagonal, and any other configuration could be provided in order to rotatably drive any known fastener or tool.

It is to be understood that the present invention is not limited to the sole embodiment described above, but encompasses any and all embodiments within the scope of the following claims.

I claim:

1. A stepless rotatable driving wrench comprising:
a head having a first service surface, an opposed second service surface, a hollow center space extending between said first service surface and said opposed second service surface, and a grasping element enabling a person to grasp said head for the purpose of rotatably driving a tool;
a stepless unidirectional clutch disposed within said hollow center space of said head;
a driver for engaging a tool to be driven, wherein said driver is drivingly engagable by said stepless unidirectional clutch, and wherein said driver has a first non-circular drive end, an opposed second non-circular drive end, a peripheral drive surface disposed to be rotatably driven from said stepless unidirectional clutch, and length such one of said first non-circular drive end and said opposed second non-circular drive end projects from one of said first service surface of said head and said opposed second service surface of said head when the other one of said first non-circular drive end and said opposed second non-circular drive end is flush with respect to said head; and
a releasable retainer disposed to releasably and interchangeably hold said driver within said stepless unidirectional clutch such that said releasable retainer enables side driver to move between two operable positions wherein, in each one of said two operable positions, one of said first non-circular drive end of said driver and said opposed second non-circular drive end of said driver remains entirely flush with said head and the other one of said first non-circular drive end of said driver and said opposed second non-circular drive end of said driver projects from said head.

2. The stepless rotatable driving wrench according to claim 1, wherein said driver has configuration substantially of a parallelepiped and said releasable retainer has a central passageway which is dimensioned and configured to enable said driver to slide along its longitudinal axis within said releasable retainer.

3. The stepless rotatable driving wrench according to claim 1, wherein said releasable retainer comprises a ball detent including a spherical ball and a spring disposed to urge said spherical ball into engagement between said driver and said head, wherein said ball detent is contained within one of said driver and said head, and the other one of said driver and said head has a notch dimensioned and configured to receive said spherical ball of said ball detent and to retain said spherical ball so as to retain said driver in a selected operable position.

4. The stepless rotatable driving wrench according to claim 1, wherein said driver has a slot formed therein and said releasable retainer has a pin fixed thereto, wherein said pin penetrates and occupies said slot formed in said driver such that said pin limits longitudinal motion of said driver within said releasable retainer to a predetermined magnitude, whereby loss of said driver from said head is prevented.

5. The stepless rotatable driving wrench according to claim 1, wherein said first head has a fixed interference member acting to prevent loss of said driver through said first service surface and a removable retainer which is engageable with said opposed second service surface of said head and which said removable retainer is disposed to prevent loss of said driver through said opposed second service surface of said head.

6. The stepless rotatable driving wrench according to claim 5, wherein said head has a groove formed in said hollow center space proximate said opposed second service surface of said head, and said removable retainer comprises a clip which is dimensioned and configured to seat within said groove and when seated within said groove, said clip opposes loss of said driver from said head by interference therewith.

7. The stepless rotatable driving wrench according to claim 1, wherein said grasping element comprises a lever handle of length greater than the greatest diameter of said head, having a proximal end fixed to said head of said driving wrench and a distal end.

8. The stepless rotatable driving wrench according to claim 7, further comprising a second wrench head fixed to said distal end of said lever handle.

9. The stepless rotatable driving wrench according to claim 8, wherein said second wrench head comprises two spaced apart opposing jaws.

10. The stepless rotatable driving wrench according to claim 1, wherein said driver has square cross sectional configuration for engaging drivable tools having a square hole for receiving a driver.

11. The stepless rotatable driving wrench according to claim 10, wherein said driver is square in cross section along at least most of its length, and said releasable retainer has a central passageway which is dimensioned and configured to cooperate with and drivably receive the cross sectional configuration of said driver.

12. The stepless rotatable driving wrench according to claim 1, wherein said central passageway of said releasable retainer is configured to receive said driver selectively in one of plural rotational orientations within said central passageway.

13. A stepless rotatable driving wrench comprising:
a head having a first service surface, an opposed second service surface, a hollow center space extending between said first service surface and said opposed second service surface, and a grasping element enabling a person to grasp said head for the purpose of rotatably driving a tool;
a stepless unidirectional clutch disposed within said hollow center space of said head;
a driver for engaging a tool to be driven, wherein said driver has a first non-circular drive end, an opposed second non-circular drive end, a peripheral drive surface disposed to be rotatably driven by said stepless unidirectional clutch, and length such one of said first non-circular drive end and said opposed second non-circular drive end projects from one of said first service surface of said head and said opposed second service surface of said head when the other one of said first non-circular drive end and said opposed second non-circular drive end is retracted within said head; and
a releasable retainer disposed to releasably hold said driver within said stepless unidirectional clutch such that said releasable retainer enables side driver to move between two operable positions wherein, in each one of said two operable positions, one of said first non-circular drive end of said driver and said opposed second non-circular drive end of said driver remains retracted within with said head and the other one of said first non-circular drive end of said driver and said opposed second non-circular drive end of said driver projects from said head, wherein said driver has a slot formed therein and said releasable retainer has a pin fixed thereto, wherein said pin penetrates and occupies said slot formed in said driver such that said pin limits longitudinal motion of said driver within said releasable retainer to a predetermined magnitude.

15. A stepless rotatable driving wrench for engaging and rotatably driving an article having a non-circular head, said stepless rotatable wrench comprising:
a head having a first service surface, an opposed second service surface, a hollow center space extending between said first service surface and said opposed second service surface, and a grasping element enabling a person to grasp said head for the purpose of rotatably driving a tool;
a stepless unidirectional clutch disposed within said hollow center space of said head; and
a releasable retainer disposed within said stepless unidirectional clutch, wherein said releasable retainer is dimensioned and configured to engage said stepless unidirectional clutch in a manner enabling said releasable retainer to be rotatably driven by said stepless unidirectional clutch, and wherein said releasable retainer has an internal non-circular tool engaging surface for engaging the head of the article to be rotatably driven.
